(19) United States
(12) Patent Application Publication
(10) Pub. No.: US 2001/0008398 A1
(43) Pub. Date: Jul. 19, 2001

(54) Recording medium, a method and a computer for executing a fighting game

(76) Inventor: Nobuhiro Komata, Tokyo (JP)

Correspondence Address: HELFGOTT & KARAS, P.C., 60th Floor, Empire State Building, New York, NY, 10118-0110, US

(21) Appl. No.: 09/758,103

(22) Filed: Jan. 10, 2001

(30) Foreign Application Priority Data
Jan. 14, 2000 (JP) 2000-40272

(51) Int. Cl. G09G 5/00

(52) U.S. Cl. 345/156

(57) ABSTRACT

A recording medium, a computer and a method for executing fighting games in an entertaining system make the exchange of combat moves by pushing simple ON/OFF switches an easier-to-use interface for users. The recording medium has a program that has a processing program that varies the destructive power and defensive power inflicted by characters within a screen of the computer, depending on the output of a controller of the computer. The method of executing a fighting game senses a pushing pressure of a user on the controller by a pressure-sensitive unit of the controller, converts same to a pressure-sensed output, and determines the destructive power and defensive power of the moves dispatched by the characters within the screen according to the pressure-sensing output of the controller. The computer has a unit which senses the pushing pressure on the controller and converts that pressure to a pressure-sensing output, and a unit which determines the destructive power and defensive power of the moves dispatched by the characters within the screen according to the pressure-sensing output of the computer.

### FIELD OF THE INVENTION

The present invention relates to a recording medium, a method and a computer for executing a fighting game for making the exchange of combat moves of fighting characters by pushing simple ON/OFF switches, an easier-to-use interface for users.

### BACKGROUND OF THE INVENTION

So-called fighting games are games in which at least two fighting characters within a screen are made to fight by the operation of controllers to determine a winner. Normally, two players each operate a controller connected to one video game machine, thus manipulating the character within the screen allocated to that player and using kicks or various other attack moves to inflict damage upon the other character, fighting until the hit point value which is the score becomes zero.

Various buttons on the controllers are allocated as switches for dispatching kicks, thrusts, defensive moves or other moves. By pushing various ON/OFF switches of the controller at the appropriate timing depending on the distance from the opponent, on the opponent's defense and the opponent's attacks, kicks, thrusts or defensive moves will score different numbers of points by inflicting damage on the opponent, or the number of points lost due to damage on one's own character will be different.

For example, a pressure-sensitive type controller was disclosed in the publication of examined Japanese utility model application No. JP-B-H1-40545, wherein a pressure-sensitive output is provided as an input to a VCO (variable control oscillator) and the output of the VCO is used for repeated fire in a game.

In addition, Japanese patent No. 2524475 discloses making a character perform a jump action in response to a pressure-sense output and the like.

### SUMMARY OF THE INVENTION

It is an object of the present invention to make the exchange of combat moves between players or the game who push simple ON/OFF switches into an easier-to-use interface for players or users.

The above and other objects of the present invention are attained by a recording medium on which is recorded a computer-readable and executable fighting game software program that comprises a program that performs processing by taking as instructions an output from a controller of the computer, which has pressure-sensitive means, wherein the software program comprises a processing program that varies the destructive power and the defensive power inflicted by characters within a screen, depending on the output of the controller.

The above objects are further attained by a method of using a computer including a controller which has pressure-sensitive means to execute a fighting game in an entertaining system, the method comprising the steps of: sensing a pushing pressure by a user on the controller by the pressure-sensitive means and converting same into a pressure-sensed output, and determining the destructive power and defensive power of the moves dispatched by the characters within the screen according to said pressure-sense output.

A computer for executing a fighting game in an entertaining system according to the present invention comprises a controller which has pressure-sensitive means; means for sensing a pushing pressure by a user on said controller by said pressure-sensitive means and converting same into a pressure-sensed output; and means for determining the destructive power and defensive power of the moves dispatched by the characters within the screen according to the pressure-sensed output.

Moreover, the computer for executing a fighting game according to the present invention may comprise a plurality of controllers each having pressure-sensitive means and converting means, whereby each of said controllers senses a pushing pressure by users on said controller by said pressure-sensitive means and converts said pressure to a pressure-sensed output; means for determining an attacking power of moves dispatched by a character within a screen of the computer controlled by one of said controllers according to said pressure-sense output, means for determining a defensive power of moves dispatched by the character within the screen controlled by the other of said controllers according to said pressure-sensed output, and means for determining a hit point value of the character depending on the magnitude of said attacking power and said defending power and the timing of the moves.

Furthermore, in the computer of the present invention, when the attacking-side character starts a move before the defending-side character, the hit point value of said defending-side character is reduced depending on an amount found by the attacking power determined according to said pressure-sensed output from which is subtracted the defensive power determined according to said pressure-sense output.

Furthermore, in the computer of the present invention, when the attacking-side character starts a move after the defending-side character, the hit point value of said defending-side character is unchanged.

### BRIEF DESCRIPTION OF THE DRAWINGS

FIG. 1 is a schematic diagram of an example of connecting an entertainment system to a controller and a TV monitor;

FIG. 2 is a schematic diagram showing an example of a fighting game;

FIG. 3 is a flowchart of processing of a fighting game that includes a program for reflecting the magnitude of the pressure-sense value in an attack or defense of the fighting game;

FIG. 4 is a perspective view of the controller connected to the entertainment system;

FIG. 5 is a block diagram of the entertainment system;

FIG. 6 is a top view of the controller;

FIG. 7 is an exploded perspective view of the second control part of the controller;

FIGS. 8A-8C are cross sectional views of the second control part of FIG. 7;

FIG. 9 is a diagram showing an equivalent circuit for a pressure-sensitive device;

FIG. 10 is a block diagram of the main parts of the controller;

FIG. 11 is an exploded perspective view of the first control part of the controller;

FIG. 12 is a cross-sectional view of the first control part of FIG. 11;

FIG. 13 is a diagram showing the circuit configuration of a resistor;

FIG. 14 is a graph showing the characteristic of the signal output;

FIG. 15 is a block diagram showing the overall constitution including the resistor; and

FIG. 16 is an exploded perspective view of the third control part of the controller.

### DETAILED DESCRIPTION OF THE PREFERRED EMBODIMENT

With this embodiment, in so-called fighting games in an entertaining system, when pressure-sensitive switches for attacks are pushed by a user, the EHP which is the enemy's hit point value is reduced depending on the pressure-sensed value thereof and the attack timing, and when pressure-sensitive switches for attacks are pushed by the user, it is possible to prevent the UHP which is the user's own hit point value, from being reduced depending on the pressure-sensed value thereof.

Thereby, it is possible to provide a system with a user interface that is improved in comparison to the repeated or continuous turning ON of a simple ON/OFF switch.

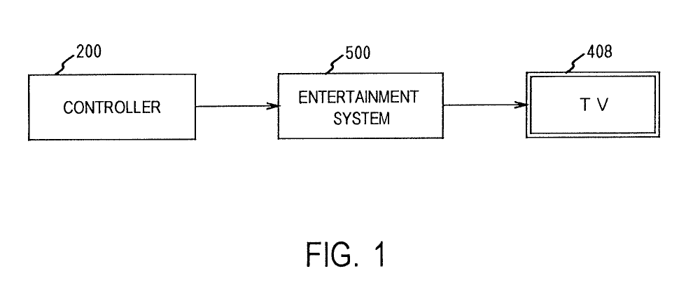

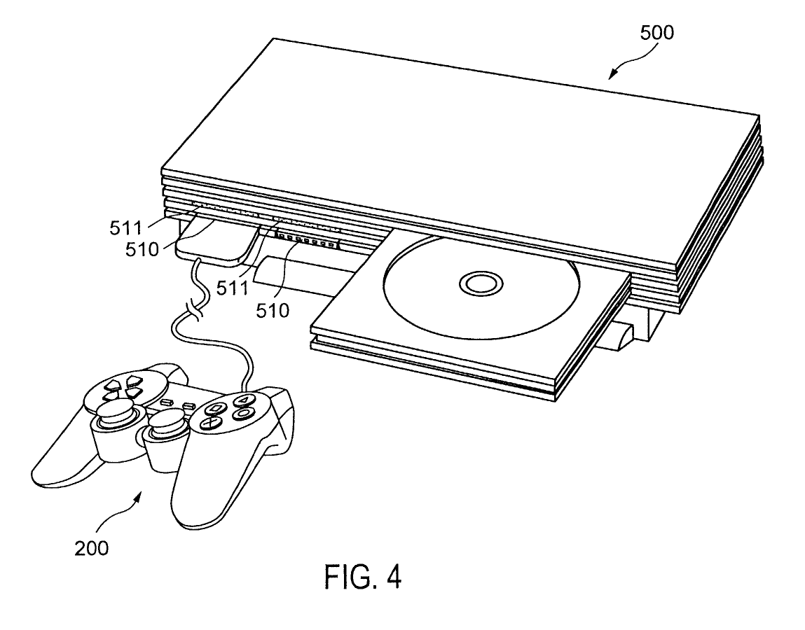

FIG. 1 is a schematic diagram showing the connection of an entertainment system 500 to a controller, to enable a user of the system to enjoy game software or video. More specificly, the embodiment of the invention is shown in FIG. 4.

As shown in this FIG. 1, a controller 200 which has buttons connected to pressure-sensitive devices positions in the interior thereof, is connected to an entertainment system 500 used for playing games or enjoying DVD video or other types of video images, and the video output terminals are connected to a television monitor 408. Here, the analog output from the pressure-sensitive devices is converted by an A/D converter to digital values in the range 0-255 and provided to the entertainment system 500.

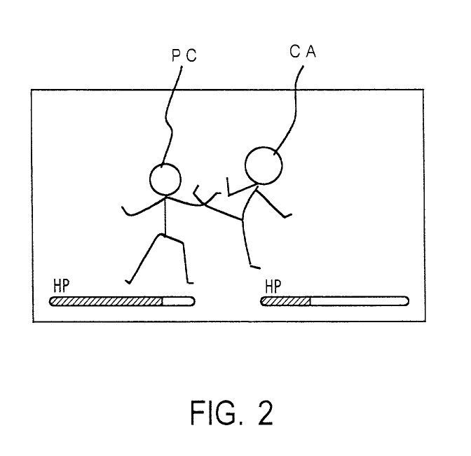

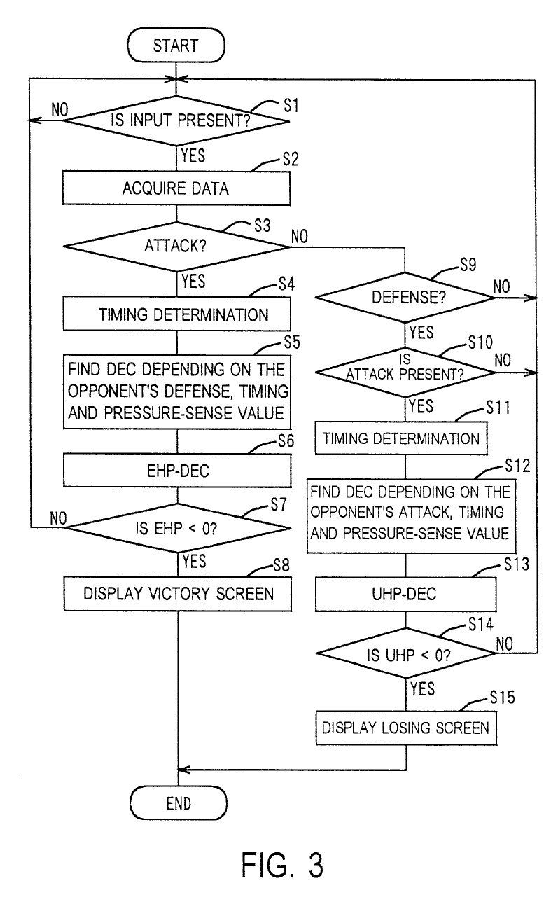

With reference to FIGS. 2 and 3, there will be described the case wherein controller 200 is operated to make characters on a screen attack and defend. FIG. 2 shows one example of a fighting game.

As shown in FIG. 2, the player character PC controlled by the player, fights against an enemy character CA controlled by the CPU or another player, and the one whose hit point value HP, which is that character's score, becomes zero first loses.

A gage symbol showing the hit point value UHP of the player character PC appears at the bottom left of the screen, while a gage symbol showing the hit point value EHP of the enemy character CA appears at the bottom right of the screen.

Conventional fighting games consist solely of attacking the opponent with a combination of button pushes, repeated hits, and continuous pushing of buttons. In addition, defense was nothing more than avoiding the attacks of the enemy character.

With this embodiment, in a fighting game, when a player operates a pressure-sensitive controller, the magnitude of the pressure-sensing value is reflected in attack and defense.

Next, with reference to FIG. 3, the method of reflecting the magnitude of the pressure-sensing value in attack and defense will be described.

The flowchart of FIG. 3 shows the processing of a fighting game that includes a program for reflecting the magnitude of the pressure-sense value in an attack or a defense. The program for reflecting the magnitude of the pressure-sense value in an attack or defense may be supplied either recorded alone upon an optical disc or other recording medium, or recorded upon said recording medium together with the game software as part of the game software. The program for reflecting the magnitude of the pressure-sense value in an attack or defense is run by the entertainment system 500 and executed by its CPU.

The meaning of supplying the program for reflecting the magnitude of the pressure-sense value in an attack or defense recorded individually on a recording medium has the meaning of preparing it in advance as a library for software development. As is common knowledge, at the time of developing software, writing all functions requires an enormous amount of time.

However, if the software functions are divided by the type of functions, for example, for moving objects (characters) and the like, they can be used commonly by various types of software, so more functions can be included.

To this end, a function such as that described in this preferred embodiment that can be used commonly may be provided to the software manufacturer side as a library program. When general functions like this are supplied as external programs in this manner, it is sufficient for the software manufacturers to write only the essential portions of the software.

The processing shown in the following flowchart of FIG. 3 is performed for each frame.

In Step S1, a decision is made as to whether or not input of pressure-sensed value data is present, and if “YES” then in Step S2 pressure-sensing values are acquired from the controller 200.

In Step S3, a decision is made as to whether or not a pressure-sensitive switch for attacks is pushed, and if “YES” then control processing moves to Step S4, but if “NO” then control processing moves to Step S9.

In Step S4, the timing is determined. To wit, a determination of timing is made based on the point in time that the player character PC attacked along with the timing at which the enemy character CA performs defensive or evasive action, determining which action occurred first or by how much the later action was delayed.

In Step S5, based on the results of the aforementioned timing determination, the distance between the player character PC and the enemy character CA, how close the attacking body part, e.g. the hand or foot, got to the enemy character CA, the decrease Dec in the hit point value EHP of the enemy character CA is calculated.

In Step S6, the decrease Dec is subtracted from the hit point value EHP of the enemy character CA.

In Step S7, a decision is made as to whether or not the hit point value EHP of the enemy character CA is less than 0, and if “YES” then control moves to Step S8 where the victory screen is displayed, but if “NO” then control processing moves back to Step On the other hand, in Step S9, a decision is made as to whether or not a pressure-sensitive switch for defending is pushed, and if “YES” then control moves to Step S10, but if “NO” then control processing moves to Step S1.

In Step S10, a decision is made as to whether or not an attack from the enemy character CA is present, and if “YES” then control moves to Step S11, but if “NO” then control processing moves back to Step S1.

In Step S11, the timing is determined. To wit, a determination of timing is made based on the point in time that the enemy character CA attacked along with the timing at which the player character PC performs defensive or evasive action, determining which action occurred first or by how much the later action was delayed.

In Step S12, based on the results of the timing determination, the distance between the player character PC and the enemy character CA, how close the attacking body part, e.g. the hand or foot, of the enemy character CA is to the player character PC, the decrease Dec in the hit point value UHP of the player character PC is calculated.

In Step S13, the decrease Dec is subtracted from the hit point value UHP of the player character PC.

In Step S14, a decision is made as to whether or not the hit point value UHP of the player character PC is less than 0, and if “YES” then control moves to Step S15 where the losing screen is displayed, but if “NO” then control moves back to Step S1.

As described above, in this embodiment, the magnitude of the pressure-sensing value is reflected in attack and defense, so it is possible to improve game enjoyment and provide a user interface that is improved in comparison to the pushing or repeated hits of simple ON/OFF switches.

In this example, combat between the CPU and a player or combat between two players is envisioned. If one of the two players is on the attack and the other is on defense, a differential is found. For example, if the pressure-sensing value of one player is “200” and the pressure-sensing value of the other player is “100” then the pressure-sensing value of the defending side is “100” lower than the pressure-sensing value of the attacking side. Therefore, the amount subtracted from the hit point value of the defending side is decreased by an amount corresponding to “−100.”

The timing is determined based on whether the attack or defense was performed first. To wit, if the timing of the attacking side is before the timing of the defending side, the difference in pressure-sense values is reflected as is in the hit point value of the defending side. In contrast, if the timing of the attacking side is later than the timing of the defending side, the pressure-sense value of the attacking side is not reflected at all in the hit point value of the defending side. Moreover, in the event that the timing of the attacking side and defending side are simultaneous, if both sides have the same magnitude of their pressure-sense values, then there is no change to the hit point values of either side. However, if the attacking side is greater than that of the defending side, then the differential is subtracted from the hit point value of the defending side.

It is noted that it is also possible to find the percent change from the previous pressure-sense value to the current pressure-sense value, and have this percent change be reflected in the attacking power or defending power. For example, if the previous pressure-sense value is 100 and the current pressure-sense value is 50, then the percent change is 50%, so the attacking power or defending power may be made ½the previous value.

In addition, a low pressure-sensing value may be allocated to a large attacking power or defending power.

In addition, it is possible to compete not for the hit point value HP but rather a score. For example, when pressure-sensitive switches for attacks are pushed, the score which is the enemy's hit point value is reduced and simultaneously the score of the player is increased depending on the pressure-sense value thereof and the attack timing, and when pressure-sensitive switches for defense are pushed, it is possible to prevent the reduction of the user's own score and the simultaneous addition of points to the enemy's score depending on the pressure-sense value thereof, so both sides compete for a higher score.

While an embodiment was described above, the present invention may also assume the following alternative example. In the working example, the pressure-sensing value as pushed by the user is used as is. However, in order to correct for differences in the body weights of users or differences in how good their reflexes are, it is possible to correct the maximum value of the user pressure-sensing value to the maximum game pressure-sensing value set by the program, and intermediate values may be corrected proportionally and used. This type of correction is performed by preparing a correction table.

In addition, the user pressure-sensing value can be corrected based upon a known function. Moreover, the maximum value of the user pressure-sensing value rate of change may be corrected to the maximum game pressure-sense value rate of change set in the program, and intermediate values can be proportionally corrected and used. For more details about this method, refer to the present inventors' Japanese patent application No. 2000-40257 and the corresponding PCT application JP/(Applicant's file reference SC00097WO00).

FIG. 4 is a diagram showing the controller 200 connected to entertainment system 500. The controller 200 is removably connected to the entertainment system 500, and the entertainment system 500 is connected to television monitor 408.

The entertainment system 500 reads the program for a computer game from recording media upon which that program is recorded and by executing the program, displays characters on the television monitor 408. The entertainment system 500 has various built-in functions for DVD (Digital Versatile Disc) playback, CDDA (compact disc digital audio) playback and the like. The signals from the controller 200 are also processed as one of the aforementioned control functions within the entertainment system 500, and the content thereof may be reflected in the movement of characters and the like, on the television monitor 408.

While this depends also on the content of the computer game program, controller 200 may be allocated functions for moving the characters display on the television monitor 408 in the directions up, down, left or right.

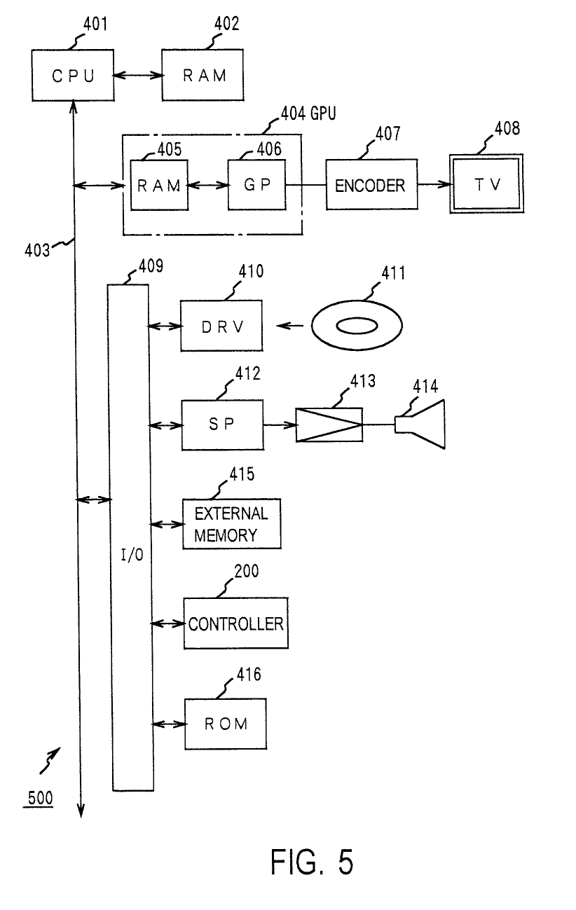

With reference to FIG. 5, here follows a description of the interior of the entertainment system 500 shown in FIG. 4. FIG. 5 is a block diagram of the entertainment system 500.

A CPU 401 is connected to RAM 402 and a bus 403, respectively. Connected to bus 403 are a graphics processor unit (GPU) 404 and an input/output processor (I/O) 409, respectively. The GPU 404 is connected via an encoder 407 for converting a digital RGB signal or the like into the NTSC standard television format, for example, to a television monitor (TV) 408 as a peripheral. Connected to the I/O 409 are a driver (DRV) 410 used for the playback and decoding of data recorded upon an optical disc 411, a sound processor (SP) 412, an external memory 415 consisting of flash memory, controller 200 and a ROM 416 which records the operating system and the like. The SP 412 is connected via an amplifier 413 to a speaker 414 as a peripheral.

Here, the external memory 415 may be a card-type memory consisting of a CPU or a gate array and flash memory, which is removably connected via a connector 511 to the entertainment system 500 shown in FIG. 4. The controller 200 is configured such that, when a plurality of buttons provided thereupon are pushed, it gives instructions to the entertainment system 500. In addition, the driver 410 is provided with a decoder for decoding images encoded based upon the MPEG standard.

The description will be made now as to how the images will be displayed on the television monitor 408 based on the operation of controller 200. It is assumed that data for objects consisting of polygon vertex data, texture data and the like recorded on the optical disc 411 is read by the driver 410 and stored in the RAM 402 of the CPU 401.

When instructions from the player via controller 200 are provided as an input to the entertainment system 500, the CPU 401 calculates the three-dimensional position and orientation of objects with respect to the point of view based on these instructions. Thereby, the polygon vertex data for objects defined by X, Y, Z coordinate values are modified variously. The modified polygon vertex data is subjected to perspective conversion processing and converted into two-dimensional coordinate data.

The regions specified by two-dimensional coordinates are so-called polygons. The converted coordinate data, Z data and texture data are supplied to the GPU 404. Based on this converted coordinate data, Z data and texture data, the GPU 404 performs the drawing process by writing texture data sequentially into the Ram 405. One frame of image data upon which the drawing process is completed, is encoded by the encoder 407 and then supplied to the television monitor 408 and displayed on its screen as an image.

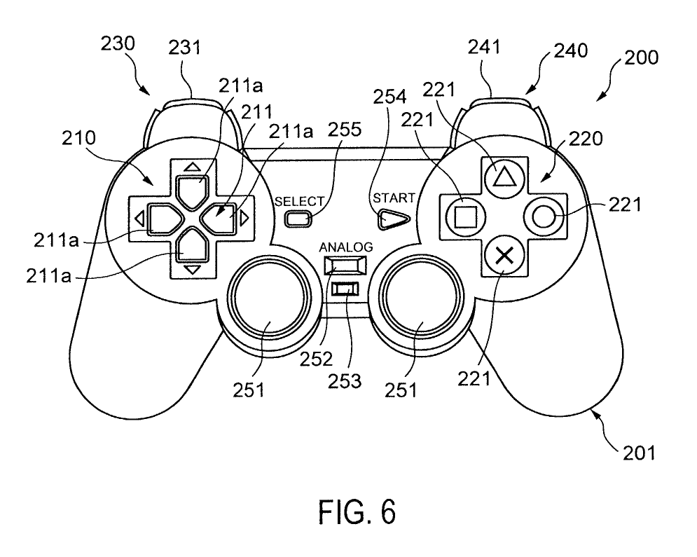

FIG. 6 is a top view of controller 200. The controller 200 includes a unit body 201 on the top surface of which are provided first and second control parts 210 and 220, and on the side surface of which are provided third and fourth control parts 230 and 240 of the controller 200.

The first control part 210 of the controller is provided with a cruciform control unit 211 used for pushing control, and the individual control keys 211a extending in each of the four directions of the control unit 211 form a control element. The first control part 210 is the control part for providing movement to the characters displayed on the screen of the television receiver, and has the functions for moving the characters in the up, down, left and right directions by pressing the individual control keys 211a of the cruciform control unit 211.

The second control part 220 is provided with four cylindrical control buttons 221 (control elements) for pushing control. The individual control buttons 221 have identifying marks such as “∘” (circle), “×” (cross), “Δ” (triangle) and “□” (quadrangle) on their tops, in order to easily identify the individual control buttons 221. The functions of the second control part 220 are set by the game program recorded upon the optical disc 411, and the individual control buttons 221 may be allocated functions that change the state of the game characters, for example. For example, the control buttons 221 may be allocated functions for moving the left arm, right arm, left leg and right leg of the character.

The third and fourth control parts 230 and 240 of the controller have nearly the same structure, and both are provided with two control buttons 231 and 241 (control elements) for pushing control, arranged above and below. The functions of these third and fourth control parts 230 and 240 are also set by the game program recorded upon the optical disc, and may be allocated functions for making the game characters do special actions, for example.

Moreover, two joy sticks 251 for performing analog operation are provided upon the unit body 201 shown in FIG. 6. The joy sticks 251 can be switched and used instead of the first and second control parts 210 and 220 described above. This switching is performed by means of an analog selection switch 252 provided upon the unit body 201. When the joy sticks 251 are selected, a display lamp 253 provided on the unit body 201 lights, indicating the state wherein the joy sticks 251 are selected.

It is to be noted that on unit body 201 there are also provided a start switch 254 for starting the game and a select switch 255 for selecting the degree of difficulty or the like at the start of a game, and the like.

The controller 200 is held by the left hand and the right hand and is operated by the other fingers, and in particular the thumbs are able to operate most of the buttons on the top surface.

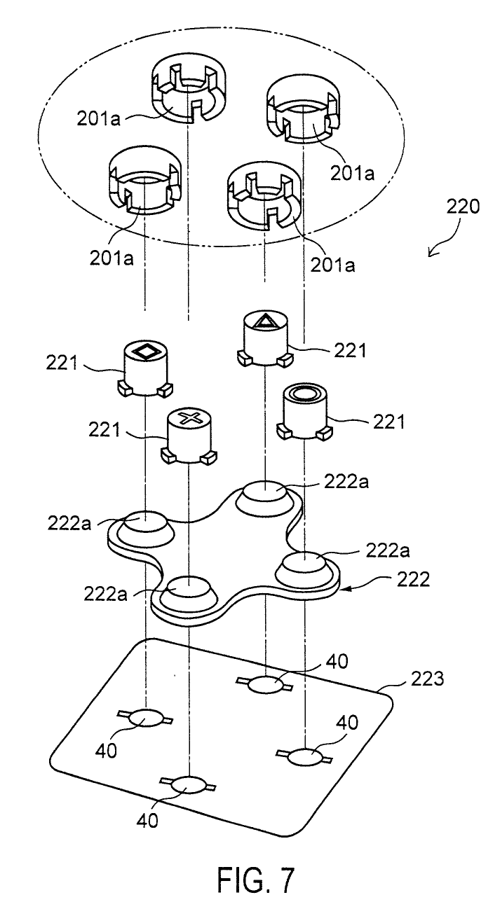

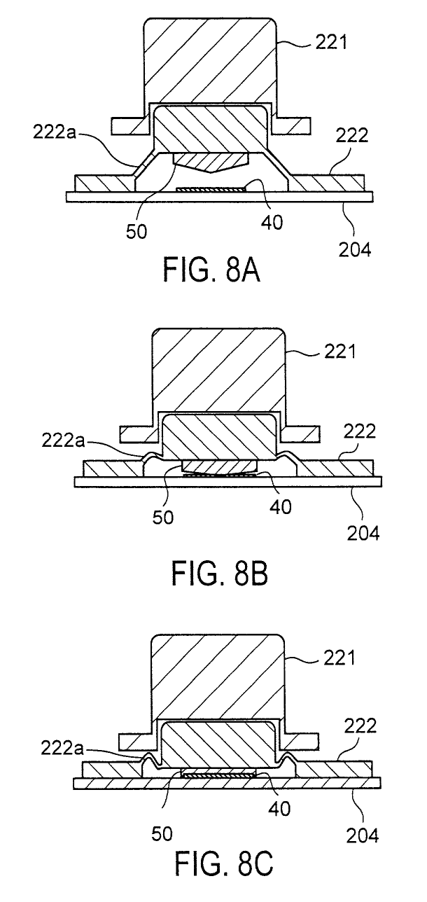

FIG. 7 and FIGS. 8A-8C are, respectively, an exploded respective view and cross-sectional views showing the second control part of the controller.

As shown in FIG. 7, the second control part 220 has four control buttons 221 which serve as the control elements, an elastic body 222, and a sheet member 223 provided with resistors 40. The individual control buttons 221 are inserted from behind through insertion holes 201a formed on the upper surface of the unit body 201. The control buttons 221 inserted into the insertion holes 201a are able to move freely in the axial direction.

The elastic body 222 is made of insulating rubber or the like and has elastic areas 222a which protrude upward, and the lower ends of the control buttons 221 are supported upon the upper walls of the elastic areas 222a. When the control buttons 221 are pressed, the inclined-surface portions of these elastic areas 222a flex so that the upper walls move together with the control buttons 221. On the other hand, when the pushing pressure on the control buttons 221 is released, the flexed inclined-surface portions of elastic areas 222a elastically return to their original shape, pushing up the control buttons 221. The elastic body 222 functions as a spring means whereby control buttons 221 which had been pushed in by a pushing action are returned to their original positions. As shown in FIGS. 8A-8C, conducting members 50 are attached to the rear surface of the elastic body 222.

The sheet member 223 consists of a membrane or other thin sheet material which has flexibility and insulating properties. Resistors 40 are provided in appropriate locations on this sheet member 223 and these resistors 40 and conducting member 50 are each disposed such that they face one of the control buttons 221 via the elastic body 222. The resistors 40 and conducting members 50 form pressure-sensitive devices. These pressure-sensitive devices consisting of resistors 40 and conducting members 50 have resistance values that vary depending on the pushing pressure received form the control buttons 221.

To describe this in more detail, as shown in FIGS. 8A-8C, the second control part 220 is provided with control buttons 221 as control elements, the elastic body 222, conducting members 50 and resistors 40. Each conducting member 50 may be made of conductive rubber which has elasticity, for example, and has a conical shape with its center as a vertex. The conducting members 50 are adhered to the inside of the top surface of the elastic areas 222a formed in the elastic body 222.

In addition, the resistors 40 may be provided on an internal board 204, for example, opposite the conducting members 50, so that the conducting members 50 come into contact with resistors 40 together with the pushing action of the control buttons 221. The conducting member 50 deforms, depending on the pushing force on the control button 221 (namely the contact pressure with the resistor 40), so as shown in FIGS. 8B and 8C, the surface area in contact with the resistor 40 varies depending on the pressure. When the pressing force on the control button 221 is weak, as shown in FIG. 8B, only the area near the conical tip of the conducting member 50 is in contact. As the pressing force on the control button 221 becomes stronger, the tip of the conducting member 50 deforms gradually so the surface area in contact expands.

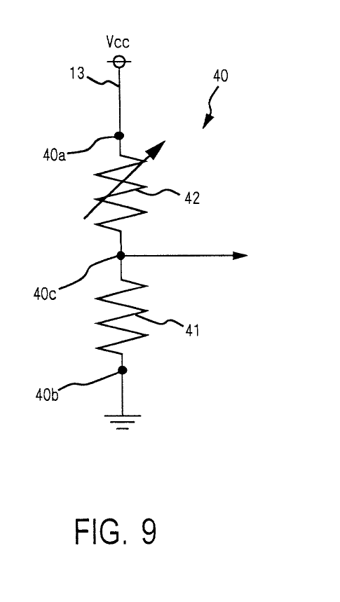

FIG. 9 is a diagram showing an equivalent circuit for a pressure-sensitive device consisting of a resistor 40 and conducting member 50. As shown in this diagram, the pressure-sensitive device is inserted in series in a power supply line 13, where the voltage V_{cc} is applied between the electrodes 40a and 40b. As shown in this diagram, the pressure-sensitive device is divided into a variable resistor 42 that has the relatively small resistance value of the conducting member 50, and a fixed resistor 41 that has the relatively large resistance value of the resistor 40. Among these, the portion of the variable resistor 42 is equivalent to the portion of resistance in the contact between the resistor 40 and the conducting member 50, so the resistance value of the pressure-sensitive device varies depending on the surface area of contact with the conducting member 50.

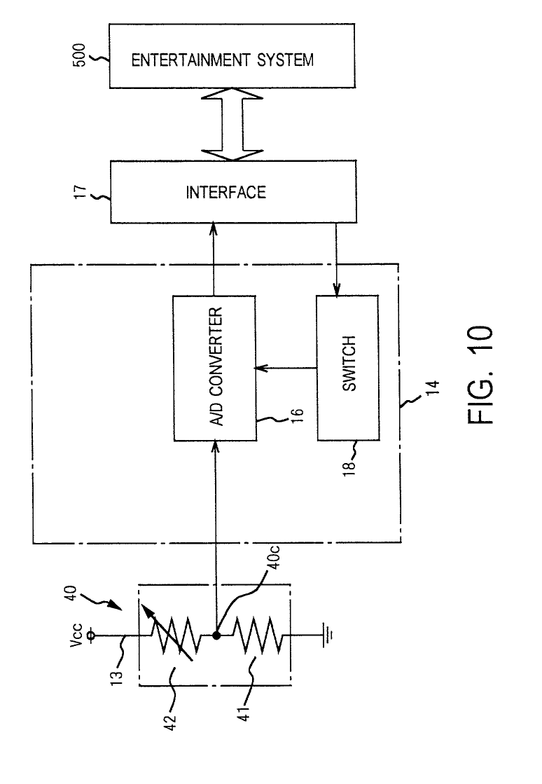

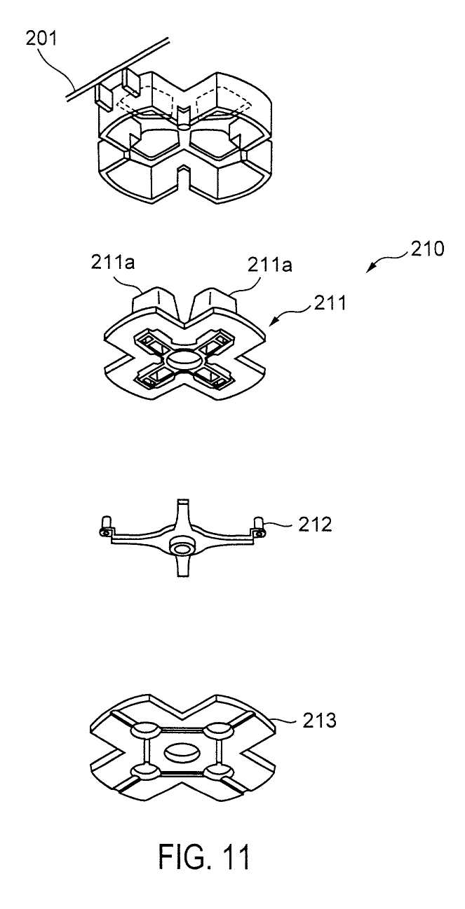

When the conducting member 50 comes into contact with the resistor 40, in the portion of contact, the conducting member 50 becomes a bridge instead of the resistor 40 and a current flows, so the resistance value becomes smaller in the portion of contact. Therefore, the greater the surface area of contact between the resistor 40 and conducting member 50, the lower the resistance value of the pressure-sensitive device becomes. In this manner, the entire pressure-sensitive device can be understood to be a variable resistor. It is noted that in FIGS. 8A-8C show only the contact portion between the conducting member 50 and resistor 40 which forms the variable resistor 42 of FIG. 9, but the fixed resistor of FIG. 11 is omitted form FIG. 10.

In the preferred embodiment, an output terminal is provided near the boundary between the variable resistor 42 and fixed resistor 41, namely near the intermediate point of the resistors 40, and thus a voltage stepped down from the applied voltage V_{cc} by the amount the variable resistance is extracted as an analog signal corresponding to the pushing pressure by the user on the control button 221.

First, since a voltage is applied to the resistor 40 when the power is turned on, even if the control button 221 is not pressed, a fixed analog signal (voltage) Vₘᵢₙ is provided as the output from the output terminal 40c. Next, even if the control button 221 is pressed, the resistance value of this resistor 40 does not change until the conducting member 50 contacts the resistor 40, so the output from the resistor 40 remains unchanged at Vₘᵢₙ. If the control button 221 is pushed further and the conducting member 50 comes into contact with the resistor 40, the surface area of contact between the conducting member 50 and the resistor 40 increases in response to the pushing pressure on the control button 221, and thus the resistance of the resistor 40 is reduced so the analog signal (voltage) output from the output terminal 40c of the resistor 40 increases. Furthermore, the analog signal (voltage) output form the output terminal 40c of the resistor 40 reaches the maximum Vₘₐₓ when the conducting member 50 is most deformed.

FIG. 10 is a block diagram showing the main parts of the controller 200.

An MPU 14 mounted on the internal board of the controller 200 is provided with a switch 18, an A/D converter 16 and two vibration generation systems. The analog signal (voltage) output from the output terminal 40c of the resistor 40 is provided as the input to the A/D converter 16 and is converted to a digital signal.

The digital signal output from the A/D converter 16 is sent via an interface 17 provided upon the internal board of the controller 200 to the entertainment system 500 and the actions of game characters and the like are executed based on this digital signal.

Changes in the level of the analog signal output from the output terminal 40c of the resistor 40 correspond to changes in the pushing pressure received form the control button 221 (control element) as described above. Therefore, the digital signal outputted from the A/D converter 16 corresponds to the pushing pressure on the control button 221 (control element) from the user. If the actions of the game characters and the like are controlled based on the digital signal that has such a relationship with the pushing pressure from the user, it is possible to achieve smoother and more analog-like action than with control based on a binary digital signal based only on zeroes and ones.

The configuration is such that the switch 18 is controlled by a control signal sent from the entertainment system 500 based on a game program recorded on an optical disc 411. When a game program recorded on optical disc is executed by the entertainment system 500, depending on the content of the game program, a control signal is provided as an output to specify whether the A/D converter 16 is to function as a means of providing output of a multi-valued analog signal, or as a means of providing a binary digital signal. Based on this control signal, the switch 18 is switched to select the function of the A/D converter 16.

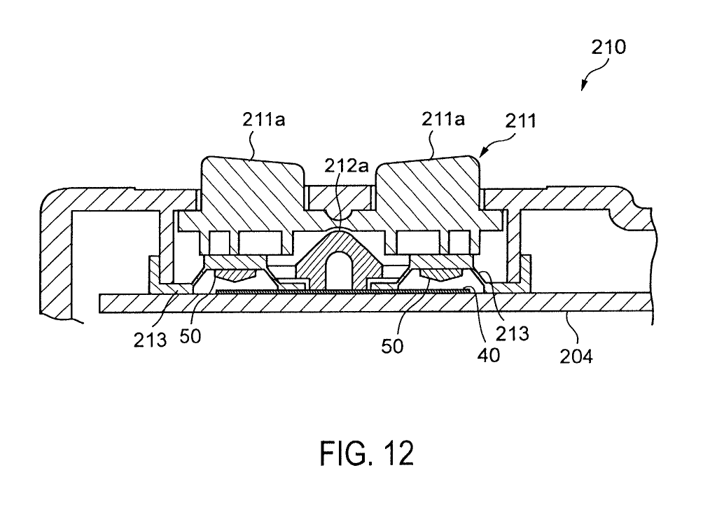

FIGS. 11 and 12 show the configuration of the first control part of the controller.

As shown in FIG. 11, the first control part 210 includes a cruciform control unit 211, a spacer 212 that positions this control unit 211, and an elastic body 213 that elastically supports the control unit 211. Moreover, as shown in FIG. 12, a conducting member 50 is attached to the rear surface of the elastic body 213, and the configuration is such that resistors 40 are disposed at the positions facing the individual control keys 211a (control elements) of the control unit 211 via the elastic body 213.

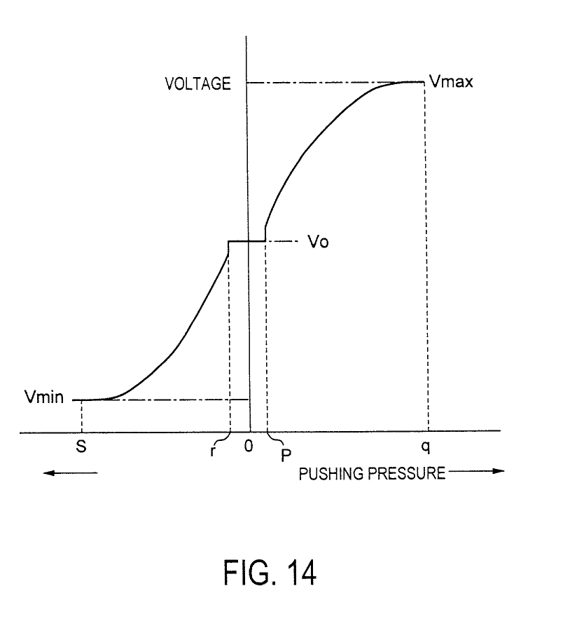

The overall structure of the first control part 210 has already been made public knowledge in the publication of unexamined Japanese patent application No. JP-A-H8-163672. The control unit 211 uses a hemispherical projection 212a formed in the center of the spacer 212 as a fulcrum, and the individual control keys 211a (control elements) are assembled such that they can push on the resistor 40 side (see FIG. 14).

Conducting members 50 are adhered to the inside of the top surface of the elastic body 213 in positions corresponding to the individual control keys 211a (control elements) of the cruciform control unit 211. In addition, the resistors 40 with a single structure are disposed such that they face the individual conducting members 50.

When the individual control keys 211a which are control elements are pushed, the pushing pressure acts via the elastic body 213 on the pressure-sensitive devices consisting of a conducting member 50 and resistor 40, so that its electrical resistance value varies depending on the magnitude of the pushing pressure.

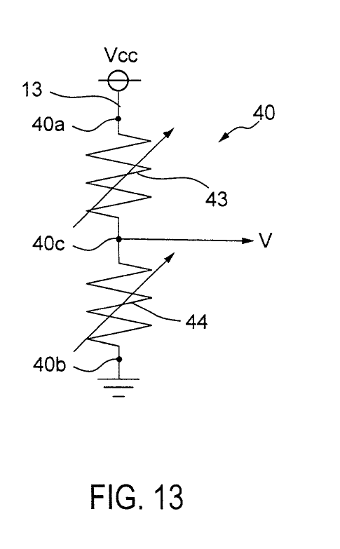

FIG. 13 is a diagram showing the circuit configuration of the resistor. As shown in FIG. 13, the resistor 40 is inserted in series in a power supply line 13, where a voltage is applied between the electrodes 40a and 40b. The resistance of this resistor 40 is illustrated schematically, as shown in this diagram; the resistor 40 is divided into first and second variable resistors 43 and 44.

Among these, the portion of the first variable resistor 43 is in contact, respectively, with the conducting member 50 that moves together with the control key (up directional key) 211a for moving the character in the up direction, and with the conducting member 50 that moves together with the control key (left directional key) 211a for moving the character in the left direction, so its resistance value varies depending on the surface area in contact with these conducting members 50.

In addition, the portion of the second variable resistor 44 is in contact, respectively, with the conducting member 50 that moves together with the control key (down directional key) 211a for moving the character in the down direction, and with the conducting member 50 that moves together with the control key (right directional Key) 211a for moving the character in the right direction, so its resistance value varies depending on the surface area in contact with these conducting members 50.

Moreover, an output terminal 40c is provided intermediate between the variable resistors 43 and 44, and an analog signal corresponding to the pushing pressure on the individual control keys 211a (control elements) is providing as output from this output terminal 40c.

The output from the output terminal 40c can be calculated from the ratio of the split in resistance value of the first and second variable resistors 43 and 44. For example, if R1 is the resistance value of the first variable resistor 43, R2 is the resistance value of the second variable resistor 44 and V_{cc} is the power supply voltage, then the output voltage V appearing at the output terminal 40c can be expressed by the following equation.

V=V_{cc}×R2/(R1+R2)

Therefore, when the resistance value of the first variable resistor 43 decreases, the output voltage increases, but when the resistance value of the second variable resistor 44 decreases, the output voltage also decreases.

FIG. 14 is a graph showing the characteristic of the analog signal (voltage) outputted from the output terminal of the resistor.

First, since a voltage is applied to the resistor 40 when the power is turned on, even if the individual control keys 211a of the control unit 211 are not pressed, a fixed analog signal (voltage) V₀ is provided as output form the output terminal 40c (at position 0 in the graph).

Next, even if one of the individual control keys 221a is pressed, the resistance value of this resistor 40 does not change until the conducting member 50 contacts the resistor 40, and the output from the resistor 40 remains unchanged at V₀.

Furthermore, if the up-directional key or left-directional key is pushed until the conducting member 50 comes into contact with the first variable resistor 43 portion of the resistor 40 (at position p in the graph), thereafter the surfaced area of contact between the conducting member 50 and the first variable resistor 43 portion increases in response to the pushing pressure on the control key 211a (control element), and thus the resistance of that portion is reduced so the analog signal (voltage) output from the output terminal 40c of the resistor 40 increases. Furthermore, the analog signal (voltage) output form the output terminal 40c of the resistor 40 reaches the maximum Vₘₐₓ when the conducting member 50 is most deformed (at position q in the graph).

On the other hand, if the down-directional key or right-directional key is pushed until the conducting member 50 comes into contact with the second variable resistor 44 portion of the resistor 40 (at position r in the graph), thereafter the surface area of contact between the conducting member 50 and the second variable resistor 44 portion increases in response to the pushing pressure on the control key 211a (control element), and thus the resistance of that portion is reduced, and as a result, the analog signal (voltage) output from the output terminal 40c of the resistor 40 decreases. Furthermore, the analog signal (voltage) output form the output terminal 40c of the resistor 40 reaches the minimum Vₘᵢₙ when the conducting member 50 is most deformed (at position s in the graph).

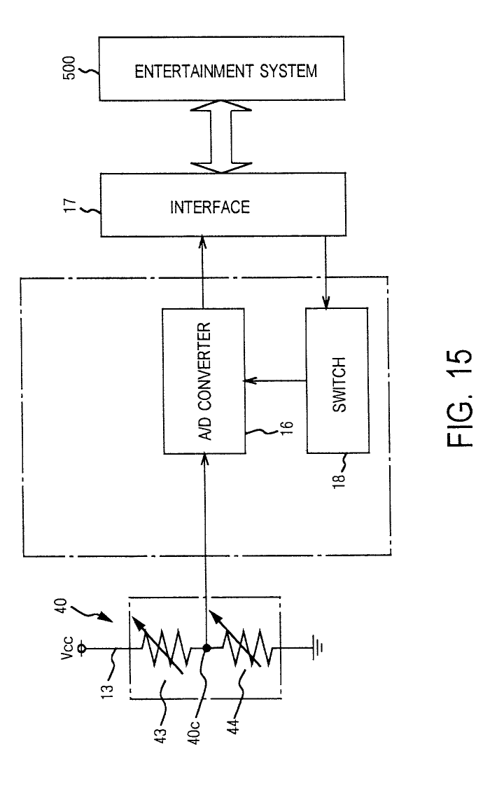

As shown in FIG. 15, the analog signal (voltage) output from the output terminal 40c of the resistor 40 is provided as an input to an A/D converter 16 and converted to a digital signal. It should be noted that the function of the A/D converter 16 is shown in FIG. 17 is as described previously based on FIG. 12, so a detailed description will be omitted here.

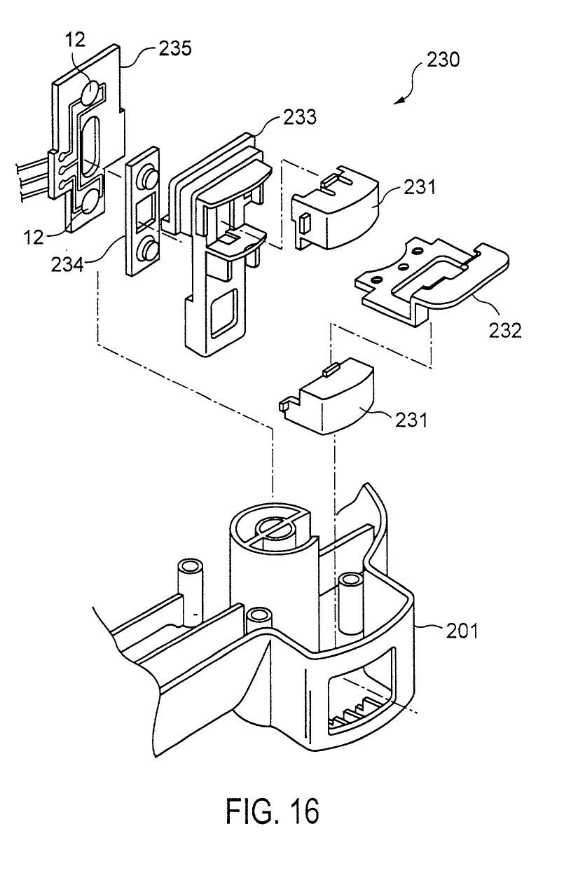

FIG. 16 is an exploded perspective view of the third control part of the controller.

The third control part 230 consists of two control buttons 231, a spacer 232 for positioning these control buttons 231 within the interior of the controller 200, a holder 233 that supports these control buttons 231, an elastic body 234 and an internal board 235, having a structure wherein resistors 40 are attached to appropriate locations upon the internal board 235 and conducting members 50 are attached to the rear surface of the elastic body 234.

The overall structure of the third control part 230 also already has been made public knowledge in the publication of unexamined Japanese patent application No. JP-A-H8-163672, so a detailed description thereof will be omitted. The individual control buttons 231 can be pushed in while being guided by the spacer 232, the pushing pressure when pressed acts via the elastic body 234 on the pressure-sensitive device consisting of a conducting member 50 and resistor 40. The electrical resistance value of the pressure-sensitive device varies depending on the magnitude of the pushing pressure it receives. It is noted that the fourth control part 240 has the same structure as that of the third control part 230 described above.

Due to the present invention, the exchange of combat moves by pushing simple ON/OFF switches can be made an easier-to-use interface for users.

Moreover, due to the present invention, the magnitude of the pressure-sense value is reflected in attack and defense, so it is possible to improve game enjoyment and provide a user interface that is improved in comparison to the pushing or repeated hits of simple ON/OFF switches.

1. A recording medium on which is recorded a computer-readable and executable fighting game software program that comprises a program that performs processing by taking as instructions an output from a controller of a computer, said controller having pressure-sensitive means, wherein
said software program comprises a processing program that varies a destructive power and a defensive power inflicted by objects within a screen of the computer, depending on the output of said controller.

2. The recording medium according to claim 1, wherein said destructive power and said defensive power are variable and determined depending on the rate of change per unit time of an output value of said controller.

3. A method executing a fighting game by using a computer including a controller which has pressure-sensitive means to execute a fighting game, in an entertaining system, the method comprising the steps of:
sensing a pushing pressure by a user on said controller by said pressure-sensitive means and converting said pressure to a pressure-sensed output; and
determining a destructive power and a defensive power of moves dispatched by characters within the screen of the computer according to said pressure-sense output.

4. The method of executing a fighting game according to claim 3, wherein
in said step of determining the destructive power and defensive power of the moves dispatched by the characters within the screen according to said pressure-sense output, the destructive power and the defensive power are determined depending on the rate of change per unit time of an output value of said controller.

5. A computer for executing a fighting game in an entertaining system comprising:
a controller which includes pressure-sensitive means;
means for sensing a pushing pressure by a user on said controller, by said pressure-sensitive means and converting said pressure sensing to a pressure-sensing output; and
means for determining a destructive power and a defensive power of moves dispatched by characters within a screen of the computer according to said pressure-sensing output.

6. The computer according to claim 5, wherein:
said means for determining the destructive power and defensive power of the moves dispatched by the characters within the screen in relation to said pressure-sense output includes means for determining the destructive power and defensive power depending on the rate of change per unit time of the output value of said controller.

7. A computer for executing a fighting game in an entertaining system comprising:
a plurality of controllers each having pressure-sensing means;
means for sensing in each of said controllers a pushing pressure by a user on said controller by respective pressure-sensitive means and converting said pressure to a pressure-sensing output;
means for determining an attacking power of moves dispatched by a character within a screen controlled by one of said controllers according to said pressure-sensing output;
means for determining the defensive power of the moves dispatched by the character within the screen controlled by another of said controllers according to said pressure-sensing output; and
means for determining a hit point value of the character depending on the magnitude of said attacking power and said defending power and the timing of moves.

8. The computer according to claim 7, wherein, when an attacking-side character starts a move before a defending-side character, a hit point value of said defending-side character is reduced depending on an amount found by the attacking power determined according to said pressure-sensing output from which is subtracted the defensive power determined according to said pressure-sense output.

9. The computer according to claim 7, wherein, when an attacking-side character starts a move after a defending-side character, a hit point value of said defending-side character is unchanged.
